(19) United States
(12) Patent Application Publication
(10) Pub. No.: US 2016/0116125 A1
(43) Pub. Date: Apr. 28, 2016

(54) Integrated Lighting Systems and Methods of Powering the Same

(71) Applicant: ABL IP Holding LLC, Conyers, GA (US)

(72) Inventors: Stephen H. Lydecker, Snellville, GA (US); Charles H. Fails, Marietta, GA (US); Forrest S. McCanless, Oxford, GA (US)

(21) Appl. No.: 14/920,551

(22) Filed: Oct. 22, 2015

Related U.S. Application Data
(60) Provisional application No. 62/067,164, filed on Oct. 22, 2014.

(51) Int. Cl. F21S 8/04; F21V 23/06; F21V 23/02

(52) U.S. Cl. CPC F21S 8/046; F21V 23/02; F21V 23/06

(57) ABSTRACT

Described are integrated lighting systems incorporating ambient lighting, task lighting, and/or emergency lighting into a single, aesthetically pleasing lighting system. Main line power is directed to an ambient lighting fixture, and then may be transferred to one or more additional ambient lighting fixtures. The ambient lighting fixtures may include a power supply and receptacle to transfer excess power to a task or emergency lighting fixture through a low-power cord. The cord and receptacle allow the task or emergency lighting fixture to be easily connected or disconnected from the ambient lighting fixtures without the need for a trained electrician. A similar power delivery system may also be used to easily connect or disconnect emergency lighting fixtures from a dedicated emergency power source. The resulting lighting system allows for easy adjustment or tailoring of the lighting conditions to the changing needs of a space without requiring special training or personnel.

### CROSS REFERENCE TO RELATED APPLICATIONS

This application claims the benefit of U.S. Provisional Application Ser. No. 62/067164 (“the '164 application”), filed on Oct. 22, 2014 and entitled “Recessed Task and Emergency Lighting and Methods of Powering the Same.” The '164 application is hereby incorporated in its entirety by this reference.

### FIELD OF THE INVENTION

Embodiments of the invention relate to recessed lighting systems and methods for delivering power to task and emergency lighting fixtures.

### BACKGROUND

Many commercial buildings, particularly retail stores, typically have at least three types of lighting: ambient lighting, accent lighting (often referred to as “task” lighting) and emergency lighting. Ambient lighting provides general light to the space, emergency lighting illuminates in the event of a general power loss to the building, and task lighting is used to provide additional light to a particular area of focus, such as a product display.

The locations of the ambient and emergency lighting are typically fixed. However, it is often necessary or desirable to move and/or rearrange task lighting to illuminate a new product display in a different location.

Commercial lighting systems typically have different sources of power for ambient, task, and emergency lighting, respectively. Emergency lighting is typically connected to a battery (e.g., a nickel-cadmium battery) that is continuously charged by general or main power. If main power is lost, the emergency lighting is powered by the battery at a relatively low voltage, usually 12-56 v DC. Ambient lighting may be powered by main power operating at a comparatively high voltage, usually 277 v AC. Task lighting, by comparison, may be powered by main power operating at a lower voltage, such as 120 v AC. In most instances, a certified electrician is required in order to install and service these light sources. As a result, rearranging task lighting may be difficult and complicated.

Certain prior art systems have partially addressed the problem of multiple power sources by providing a 277 v AC to 120 v AC transformer that may be mounted above the ceiling plane or grid in a drop ceiling system. Various 120 v task lighting units can then be powered from the 277 v ambient lighting circuit. However, even in this system, an electrician is required to connect the task lighting to the transformer.

In addition, these lighting systems are typically not well-integrated in the space. Lighting units from the ambient, task, and emergency systems are installed separately, hang from different fixtures at different heights, and have different shapes or configurations, resulting in a less than desirable appearance.

### SUMMARY

Aspects of the present disclosure relate to integrated lighting systems that incorporate ambient lighting fixtures, task lighting fixtures, and/or emergency lighting fixtures into a single, aesthetically pleasing lighting system. Power may be distributed from one or more ambient lighting fixtures to one or more task lighting fixtures through low power cables that are easily and simply connected or disconnected from a power supply and/or receptacle in an ambient lighting fixture. Similarly, emergency lighting fixtures may also be connected to main power by a power cord that may be easily connected or disconnected to main line power. The resulting lighting system allows for customization of lighting conditions in a space by providing for easy movement of task and emergency lighting fixtures. The fixtures may be moved by a lay-person, and do not require special training or an electrician to tailor the lighting system to changing space requirements.

### BRIEF DESCRIPTION OF THE DRAWINGS

FIG. 1 is a top perspective view of an embodiment of an integrated lighting system with task lighting powered off an ambient lighting fixture.

FIG. 2 is a bottom perspective view of a portion of the integrated lighting system of FIG. 1.

FIG. 3 is a top perspective view of an embodiment of an integrated lighting system with emergency lighting.

FIG. 4 is a bottom perspective view of the integrated lighting system of FIG. 3.

FIG. 5 is a bottom perspective view of an embodiment of a task lighting fixture.

FIG. 6 is a bottom perspective view of the task lighting fixture of FIG. 5 with a partial ceiling panel.

FIG. 7 is a bottom perspective view of an embodiment of a lighting unit installed in the task lighting fixture of FIG. 5.

FIG. 8 is a bottom perspective view of the task lighting fixture of FIG. 5.

FIG. 9 is a top perspective view of an embodiment of an emergency lighting fixture with partial ceiling panel.

FIG. 10 is a bottom perspective view of another embodiment of an emergency lighting fixture with partial ceiling panel.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention relate to integrated lighting systems and methods for delivering electrical power to task lighting through ambient lighting fixtures to allow the task lighting to be easily moved from one location to another to tailor the lighting to the space and make the task lighting electrical connections without the need to use a certified electrician.

More specifically, the integrated lighting system utilizes excess power capacity from the ambient lighting power supply to provide electrical power to the task lighting. In certain embodiments, light emitting diodes (LEDs) may be provided for the ambient lighting. LEDs are more energy efficient than traditional light sources used in ambient light fixtures, such as fluorescent and incandescent bulbs, and thus use less power than what is provided by a standard power supply. A standard power supply provides, in some cases, 50 W of power to a light fixture. A typical 2′×2′ or 2′×4′ light fixture might only use 25-35 W of the available power, leaving excess capacity in the power supply (15-25 W in this example).

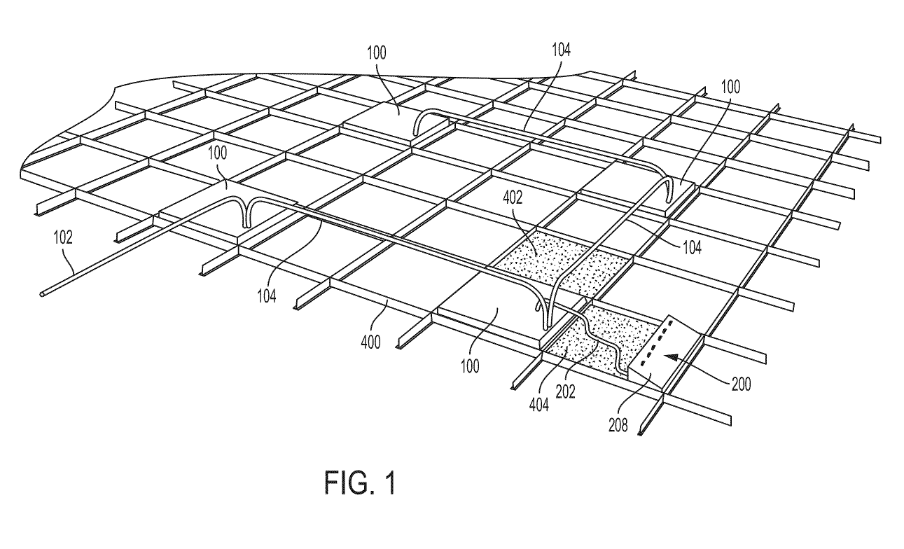

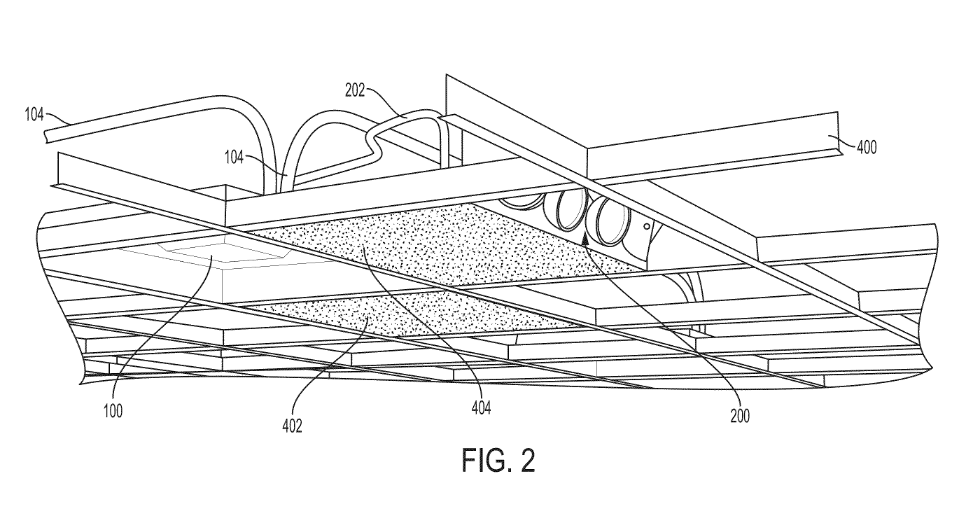

FIGS. 1 and 2 are perspective views of an embodiment of the present invention including an incoming power supply 102 feeding one or more ambient lighting fixtures 100 mounted in a ceiling grid 400. As shown, the ceiling grid 400 may be adapted to receive a standard ceiling panel 402 in locations without an ambient lighting fixture 100. The incoming power supply 102 delivers power to a first ambient lighting fixture 100, and power distribution wires 104 distribute excess power to adjacent ambient lighting fixtures 100. One or more of the ambient lighting fixtures 100 may have a power supply and receptacle (not shown) for receiving a task lighting power cord 202 from one or more task lighting fixtures 200 with a housing 208 (as described in more detail below). The one or more receptacles may be a standard power receptacle, such as but not limited to a 2-conductor, low voltage DC power plug. One or more task lighting fixtures 200 may be provided with a task lighting power cord 202 and plug that may be inserted into the one or more receptacles on the ambient lighting fixtures 100 to transfer power to the task lighting fixture 200 from the incoming power supply 102. A person skilled in the art will understand how to provide the one or more receptacles on the ambient lighting fixtures 100 and the task lighting power cord 202 and plug on the task lighting fixture 200. In this manner, one or more task lighting fixtures 200 can “slave” power from any nearby ambient lighting fixture 100 having excess power capacity. In some embodiments, the task lighting fixture 200 may be smaller than the openings of the ceiling grid 400. A partial ceiling panel 404 may be cut from an existing ceiling panel 402, or a pre-sized partial ceiling panel 404 may be provided to fill in the ceiling grid 400 space to provide a cleaner, more integrated appearance.

In certain embodiments, the task lighting power cable 202 that provides power to the task lighting fixture 200 may be a low power cable, such as a “Category 5” (cat-5) twisted pair cable. In such an embodiment, the ambient lighting fixture 100 and one or more task light fixture(s) 200 may each include a receptacle/outlet for receiving an end of the cat-5 task lighting power cable 202. It will be understood that a cat-5 cable may only be used to deliver power up to the rating of the cable, which may be limited to 25-30 W. In many circumstances, however, the excess power capacity in the ambient lighting fixture 100 will be less than the cat-5 cable power rating.

An integrated lighting system with relatively simple power connections as described above allows a non-electrician, such as a retail store worker, to place and/or locate task lighting fixtures 200 wherever they are desired and power them by simply plugging the task lighting fixtures 200 into any nearby ambient lighting fixture 100 with a power supply and/or receptacle having excess capacity.

The ambient lighting fixtures 100 may also provide for controllable power to the one or more task lighting fixtures 200. For example, the power output to the one or more task lighting fixtures 200 may be dimmable to allow for control over the intensity of the light output from the one or more task lighting fixtures 200. The control of such features may be located on the one or more task lighting fixtures 200, on the ambient lighting fixtures 100, or both. The dimming control for the ambient lighting fixtures 100 and/or task lighting fixtures 200 may include a single dimmer that dims both the ambient lighting fixture 100 and task lighting fixture 200 simultaneously, or it may include separate dimmers that allow for independent dimming of the ambient lighting fixture 100 and/or task lighting fixture 200. Independent dimming of the ambient lighting fixtures 100 and/or task lighting fixtures 200 may also be possible in an integrated lighting system where multiple ambient lighting fixtures 100 are powered from a single incoming power supply 102 with or without multiple slaved task lighting fixtures 200. For example, in certain embodiments, each ambient lighting fixture 100 may have a first dimming device to control the output of the ambient lighting fixture 100 and a second dimming device to control the lighting output of any slaved task lighting fixtures 200. In some embodiments, the task lighting fixture 200 may include its own dimming device, and the task lighting power cable 202 may include additional wiring to allow for communication between the dimming device on the task lighting fixture 200 and a wall switch.

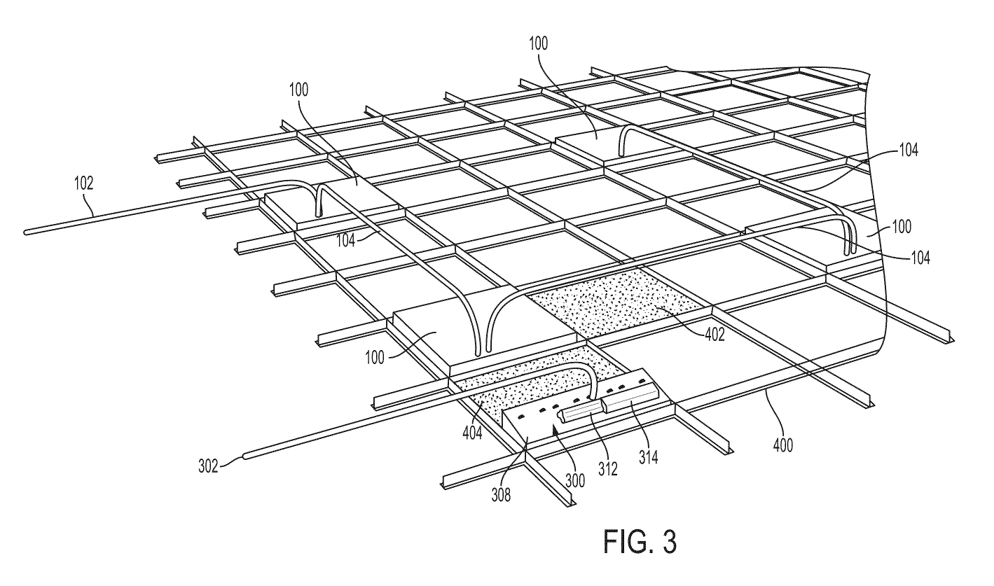

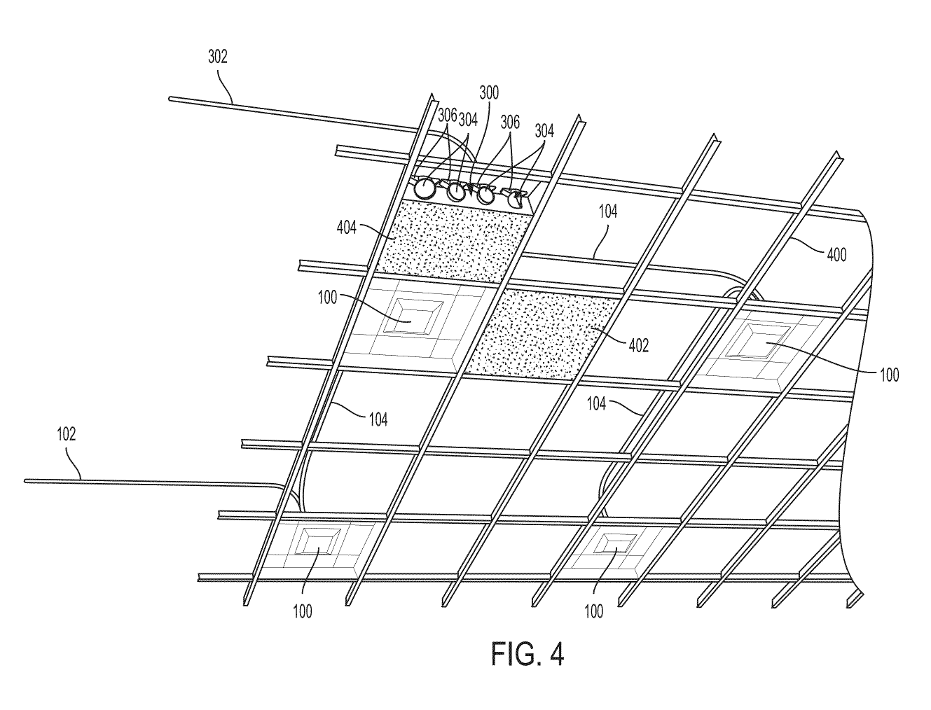

FIGS. 3 and 4 are perspective views of an integrated lighting system with one or more emergency lighting fixtures 300 that may include a driver 312 and/or battery 314 mounted to the housing 308, and, one or more emergency lighting units 304 mounted on gimbals 306. The gimbals 306 allow the emergency lighting units 304 to be posed or aimed to direct lighting as necessary. In some embodiments, the emergency lighting units 304 may be mounted on tracks or any other adjustment mechanism (as described in more detail below). Similar to the exemplary integrated lighting system of FIGS. 1 and 2, the integrated lighting system with an emergency lighting fixture 300 includes a ceiling grid 400 with one or more ambient lighting fixtures 100. An incoming power supply 102 feeds power into a first ambient lighting fixture 100, and power distribution wires 104 may deliver excess power to additional ambient lighting fixtures 100. The ceiling grid 400 may include one or more ceiling panels 402 to fill in spaces in the ceiling grid 400 that do not contain any lighting fixtures. In certain embodiments, a partial ceiling panel 404 may be used to fill in any extra space in the ceiling grid 400 where a lighting fixture, such as the emergency lighting fixture 300, does not completely fill the ceiling grid 400 space. Emergency lighting fixtures 300 may operate on a separate, emergency power supply 302 that is separate from the incoming power supply 102 for the ambient lighting fixtures 100. Each emergency lighting fixture 300 is normally connected to the emergency power supply 302, which, when energized, prevents the emergency lighting units 304 from turning on. If power through the emergency power supply 302 is lost, the emergency lighting fixture 300 automatically turns on and is powered by the battery 314. In certain embodiments, the emergency lighting fixtures 300 may include receptacles and/or a power cord and plug (not shown) similar to those described above for the task lighting fixtures 200 so as to allow the power connection(s) for the emergency lighting fixtures 300 to be easily disconnected and reconnected without the use of a certified electrician. The emergency lighting fixtures 300 may alternatively receive power through the ambient lighting fixtures 100 with a low power cable, similar to the task lighting fixtures 200.

Referring to FIGS. 1-4, exemplary installations of task lighting fixtures 200 and emergency lighting fixtures 300 within a ceiling grid 400 (i.e., above-the-ceiling) are shown. Flanges extend from at least some of the sides of the housings 208, 308 and rest on the ceiling grid 400. While the task lighting fixtures 200 and emergency lighting fixtures 300 may occupy an entire opening in the ceiling grid 400, in some embodiments, such as shown in FIGS. 1-4, the task and emergency lighting fixtures 200, 300 occupy only a portion of the ceiling grid 400 opening. In such instances, a partial ceiling panel 404 may be cut from an existing ceiling panel 402, pre-cut, or otherwise provided to fill the ceiling grid 400 opening not occupied by the task or emergency lighting fixture 200, 300. The installation of an integrated lighting system may provide at least two or three types of lighting fixtures (ambient 100, task 200, and/or emergency 300) on the same horizontal plane, such as the plane of the ceiling grid 400. The resulting installations are thus aesthetically pleasing and integrated, unlike individual lighting systems.

Furthermore, because the lighting fixtures 100, 200, 300 fit within the space provided by a ceiling panel 402 (e.g., a 2′×2′ or 2′×4′ panel), the fixtures 100, 200, 300 may be easily moved to different locations within the ceiling grid 400 as desired. When used in combination with the power delivery systems described herein, the task lighting power cord 202 for the task lighting fixture 200 may be disconnected from one ambient lighting fixture 100 and connected to another ambient lighting fixture 100 more proximate to its new location in the ceiling grid 400. Moreover, because of the relatively simple power connections described herein, the task lighting fixtures 200 may be disconnected and reconnected to the ambient lighting fixtures 100 by a non-electrician, greatly simplifying the installation and movement of the task lighting fixtures 200 as compared to existing systems. Emergency lighting fixtures 300 may be similarly moved by a non-electrician by disconnecting the power connection(s) from the emergency lighting fixture 300, moving the emergency lighting fixture 300, and reconnecting the power connection(s) to the emergency lighting fixture 300.

Embodiments of the invention also relate to systems and methods for providing above-the-ceiling (e.g., recessed) task lighting fixtures 200 and emergency lighting fixtures 300 as part of aesthetically pleasing integrated lighting systems. The above-the-ceiling lighting fixtures 200, 300 described herein may be provided separately or combined with the electrical power delivery system described above.

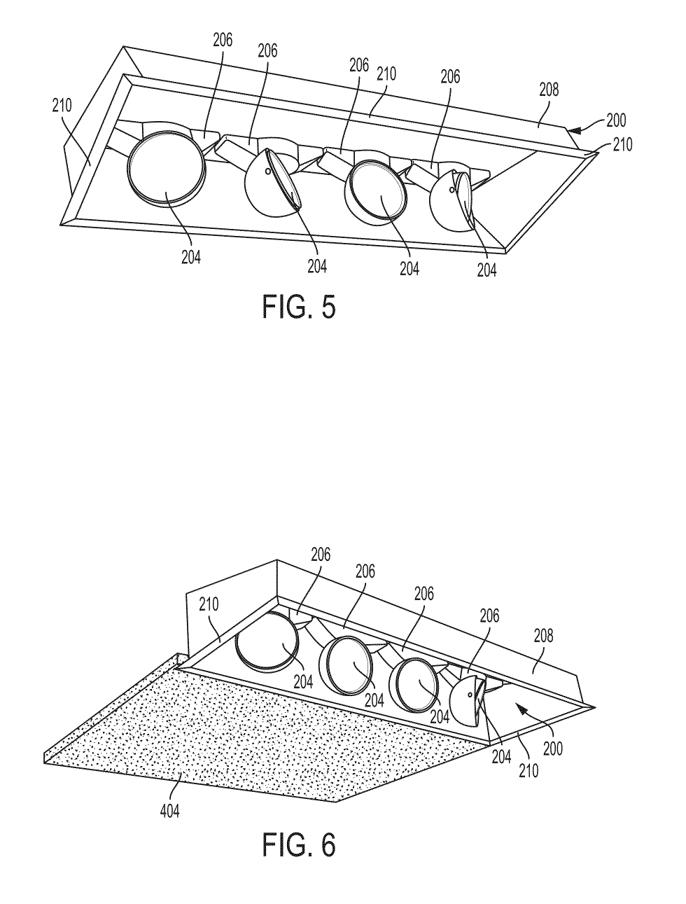

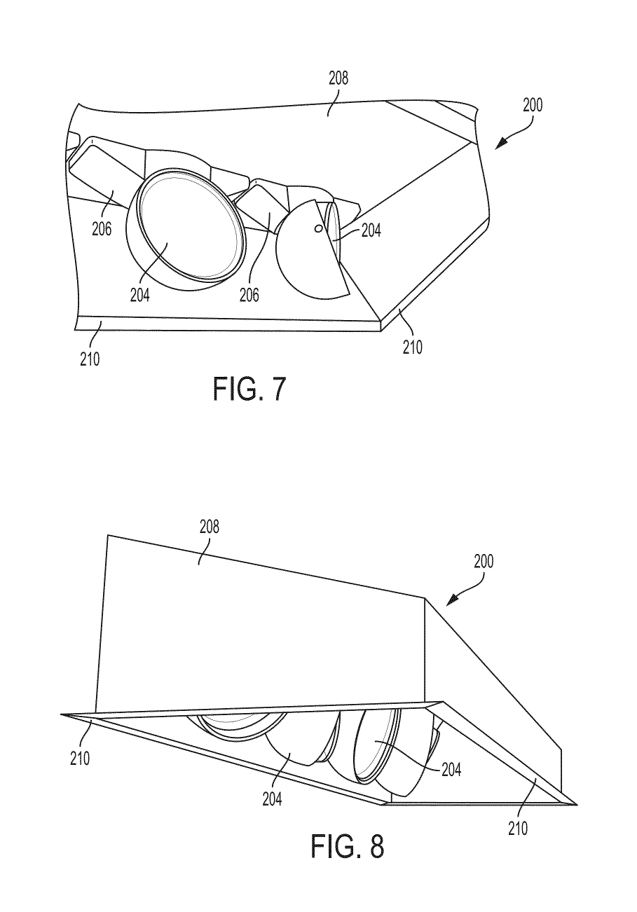

Various embodiments of the above-the-ceiling lighting fixtures 200, 300 are shown in FIGS. 5-10. Task lighting fixtures 200 and/or emergency lighting fixtures 300 may include a housing 208, 308 with one or more mounting flanges 210, 310, and one or more lighting units 204, 304 installed therein. As shown in FIGS. 6, 9, and 10, a partial ceiling panel 404 may be made from cutting down a full ceiling panel, or may be provided with the lighting fixture 200, 300, to fill in any space not occupied by the lighting fixture 200, 300 and provide an aesthetically pleasing, integrated appearance. Any type and/or number of lighting units 204, 304 may be installed in the housing 208, 308, and embodiments of the invention are not limited to the fixture configurations illustrated in the figures. Moreover, while separate emergency lighting fixtures 300 and task lighting fixtures 200 may be used, a single lighting fixture may house both emergency lighting units 304 and task lighting units 204.

The light source for the lighting units 204, 304 may be LEDs or any other suitable light source, including, but not limited to incandescent, fluorescent, or any other type of light source. In certain embodiments, LEDs may be preferred as they are more energy efficient and require less power than other light sources such as incandescent flood lights. In addition, different types of light sources may be utilized for the task lighting fixtures 200 and emergency lighting fixtures 300 as necessary or desired. As an example, higher power LED lighting units may be used in the emergency lighting fixtures 300, which generally need to be brighter than lighting units used in ambient lighting fixtures 100 and task lighting fixtures 200.

In some embodiments, the lighting units 204, 304 may be movable within the housing 208, 308 so that the direction of light output from the lighting units 204, 304, and consequently the task lighting fixture 200 and/or emergency lighting fixture 300, may be adjusted and aimed to illuminate a desired area, such as a product display or an emergency exit. By way only of example, the lighting units 204, 304 may be mounted on gimbals 206, 306 that permit the lighting units to be rotated and/or manually adjusted as desired. Alternatively, the lighting units 204, 304 may be mounted on tracks and slid within the housing 208, 308.

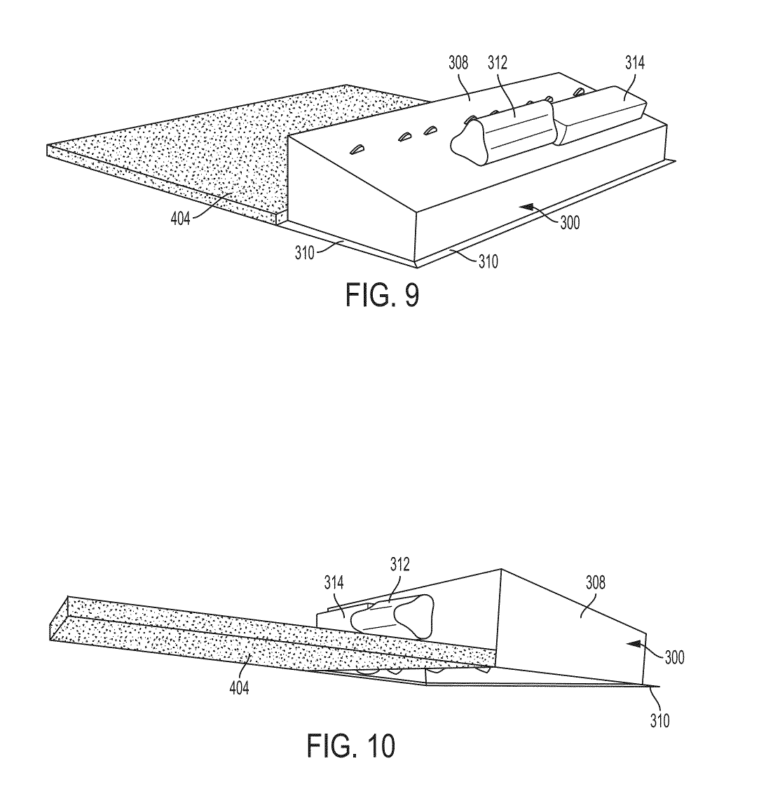

The above-the-ceiling emergency lighting fixtures 300 described herein also provide an opportunity to independently power each emergency lighting fixture 300 by providing a discreet/hidden mounting location for a driver 312 and/or battery pack 314. Two purely exemplary mounting locations for the driver 312 and/or battery pack 314 are shown in Figures. 9 (above the housing) and 10 (to the side of the housing). In such embodiments, each individual emergency lighting fixture 300 may have its own power source for powering the emergency lighting unit(s) 304 in the emergency lighting fixture 300 in the event of a general power loss.

Any of the above described components, parts, or embodiments may take on a range of shapes, sizes, or materials as necessary for a particular application of the described invention. The components, parts, or mechanisms of the described invention may be made of any materials selected for the suitability in use, cost, or ease of manufacturing. Materials including, but not limited to aluminum, stainless steel, fiber reinforced plastics, rubber, elastomers, carbon fiber, composites, polycarbonate, polypropylene, other metallic materials, or other polymers may be used to form any of the above described components.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. An integrated lighting system comprising:
an ambient lighting fixture comprising a power supply and a receptacle;
a task lighting fixture comprising one or more lighting units; and
a task lighting power cord configured to mate with the receptacle of the ambient lighting fixture,
wherein excess power from the ambient lighting fixture is transferred through the task lighting power cord to the task lighting fixture.
